(19) United States
(12) Patent Application Publication
(10) Pub. No.: US 2016/0368184 A1
(43) Pub. Date: Dec. 22, 2016

(54) BELT CONFINED CONTINUOUS MOLDING APPARATUS AND METHOD

(71) Applicants: Weaver Robert Nelson, Wichita, KS (US); Mark Anthony Wadsworth, Sedan, KS (US)

(72) Inventors: Weaver Robert Nelson, Wichita, KS (US); Mark Anthony Wadsworth, Sedan, KS (US)

(21) Appl. No.: 14/741,049

(22) Filed: Jun. 16, 2015

(51) Int. Cl. B29C 43/30; B29C 69/00; B29C 43/52; B29C 70/54; B29C 70/50

(52) U.S. Cl. CPC B29C 43/305; B29C 70/546; B29C 70/504; B29C 43/52; B29C 69/001; B29K 2105/251

(57) ABSTRACT

The disclosure relates to an apparatus and method for manufacturing a molded article from plastic material feedstock in a continuous manner. The plastic material feedstock is confined between endless belts that define molded surfaces of the article to be molded.

### BACKGROUND

1. Field

Embodiments of the present invention relate to an apparatus and method for molding plastic articles. More particularly, embodiments of the present invention relate to an apparatus and method for continuous molding of plastic articles from powdered, shredded, or granular plastic.

2. Related Art

Although many apparatuses and processes exist by which plastic may be molded or otherwise formed into articles of manufacture, many of these prior art apparatuses and processes require a plastic feedstock that has molding characteristics and uniformity consistent with virgin material. Recycled material may be incompatible with these apparatuses and processes for several reasons. First, recycled plastic material, even if pure, usually has inferior molding properties compared to virgin material due to degradation caused by prior molding and/or environmental exposure. Second, it is generally not practical to identify and segregate post-consumer plastics with a high degree of accuracy. Thus, recycled material usually contains a variable mixture of plastics, each with a different processing temperature range and viscosity profile. Third, non-plastic contaminants such as wood, rubber and metal are often present in recycled plastic and are difficult to separate reliably. These contaminants can lead to poor part quality, production stoppages, and even damage to molding equipment.

Despite these processing challenges, it is desirable to utilize recycled plastic in the manufacture of plastic articles when possible. Plastic in post-consumer form is a resource already distributed throughout the world and available almost everywhere without additional transportation costs and impacts. Increased use of recycled plastic can potentially reduce both the volume of waste that must be transported to landfills and the amount of oil that must be depleted to produce virgin plastic, thus preserving a finite resource. To capitalize on these benefits, some processes have been developed that are well suited to the molding of post-consumer recycled plastic. For example, U.S. Pat. No. 8,221,668 discloses such a process. However, the existing processes most compatible with recycled plastic materials tend to rely on closed-mold batch processing. These processes require an entire mold to be heated and cooled along with the plastic being molded, and can be scaled only by building additional molds as production rates increase. Heating and cooling a mold can require significant energy input and may limit the achievable process throughput. Building additional molds to increase production rates may be costly.

Accordingly, it is desirable to provide an apparatus and method capable of overcoming the limitations of the plastic molding processes known in the art.

### SUMMARY

The foregoing needs are met to a great extent by the present disclosure, providing a distinct advance in the art of plastic molding.

Various embodiments of the present invention provide an apparatus and a method for molding a plastic article in a continuous and energy-efficient manner that is scalable and compatible with post-consumer grade recycled plastic feedstock. The present invention is particularly suited to the manufacture of sheet stock and dimensional boards capable of being used in place of natural wood and plywood products in many applications. The feedstock may be granular, powdered, or shredded. The apparatus broadly comprises a frame, a plurality of belts, a plurality of pulleys, a force reacting structure, a drive motor, a plastic material supply hopper, a plastic material applicator, a heater, and a cooler. The frame may support the various components of the apparatus and may maintain them in proper alignment with one another. Each belt may be disposed around a plurality of pulleys and may have at least one planar portion therebetween. A planar portion of each belt may be disposed in proximity to a planar portion of each other belt such that the belts may together define a plurality of molding surfaces capable of cooperatively constraining the plastic material feedstock, moving it en masse, and ultimately forming at least some of the surfaces of an article to be molded. Additional belts may be employed to define additional molding surfaces as desired. The planar portions of the belts disposed together may form a tubular passageway therebetween having a cross section related to the desired cross section of the plastic article to be molded. Plastic material may be drawn from the hopper by the material applicator and deposited on at least one of the belts. Additional hoppers and/or material applicators may be provided to deposit additional types, grades, compositions, or forms of plastic and/or other materials onto the same and/or different belts. One or more of the belts may extend beyond the other belt or belts to facilitate access by the material applicator or applicators thereto. A drive motor may be coupled to one or more of the pulleys to drive one or more of the belts. The belts may be advanced in unison, drawing material deposited on any one of said belts into contact with the molding surfaces presented by all of the belts. It is preferred that the belts cooperate to completely encircle the plastic material during molding, but in some embodiments the belts may only partially encircle the plastic material during molding. In either case, the belts may be further advanced in unison, bringing the material into a portion of the apparatus that is heated by the heater. This may melt or soften the granular, powdered, or shredded feedstock material and form a viscous, flowable mass therefrom. The heat may also cause any blowing agent that may be present in the plastic feedstock or any portion thereof to expand, creating a foam. The force reacting structure may be disposed adjacent to a planar portion of at least one of the belts and may make sliding or rolling contact therewith. The force reacting structure may serve to resist pressure generated during molding and may maintain the planar portion of at least one of the belts in a planar configuration. The belts may be further advanced in unison, bringing the material into a portion of the apparatus that is cooled by the cooler. This may cause the viscous, flowable plastic mass to solidify into a solid mass. The belts may be advanced still further, causing the finished, shaped, and solidified plastic article to begin to emerge from the belts and from the apparatus. The apparatus may be operated on a continuous basis provided that a sufficient supply of plastic material is available in the hopper or hoppers. Therefore, a molded article of indefinite length may be manufactured. The molded article may be cut to a desired length without stopping the process by means of a flying cutter of the type known in the art of extrusion.

This summary is intended to introduce the present invention in a simplified form. Additional aspects and details of the invention and selected embodiments thereof are disclosed in the detailed description. This summary is not intended to designate particular elements of the claimed subject matter as key or essential. Nor is this summary intended to limit the scope of the claimed subject matter.

### BRIEF DESCRIPTION OF THE DRAWINGS

FIG. 1 is a perspective view of a molding apparatus constructed in accordance with an embodiment of the invention.

FIG. 2 is a schematic diagram of a molding apparatus constructed in accordance with an embodiment of the invention and incorporating two force reacting structures, both comprising shaft-mounted rollers.

FIG. 3 is cross sectional view showing cut A-A from FIG. 1.

FIG. 4 is a cross sectional view showing cut B-B from FIG. 2.

FIG. 5 is a schematic diagram of a molding apparatus constructed in accordance with an embodiment of the invention and incorporating one force reacting structure comprising recirculating rollers and another force reacting structure comprising shaft-mounted rollers.

FIG. 6 is a flow diagram illustrating a method for molding a plastic article.

### DETAILED DESCRIPTION

The following detailed description makes reference to accompanying drawings that illustrate specific embodiments of the present invention. Separate references to “an embodiment” or “one embodiment” do not necessarily refer to the same embodiment, though they may. The specific embodiments illustrated and/or described in detail in this disclosure are included to enable those skilled in the art to practice the invention. Other embodiments and variations will be apparent those skilled in the art and may be substituted without departing from the scope of the present invention. Therefore, the detailed description that follows should not be construed in a limiting sense.

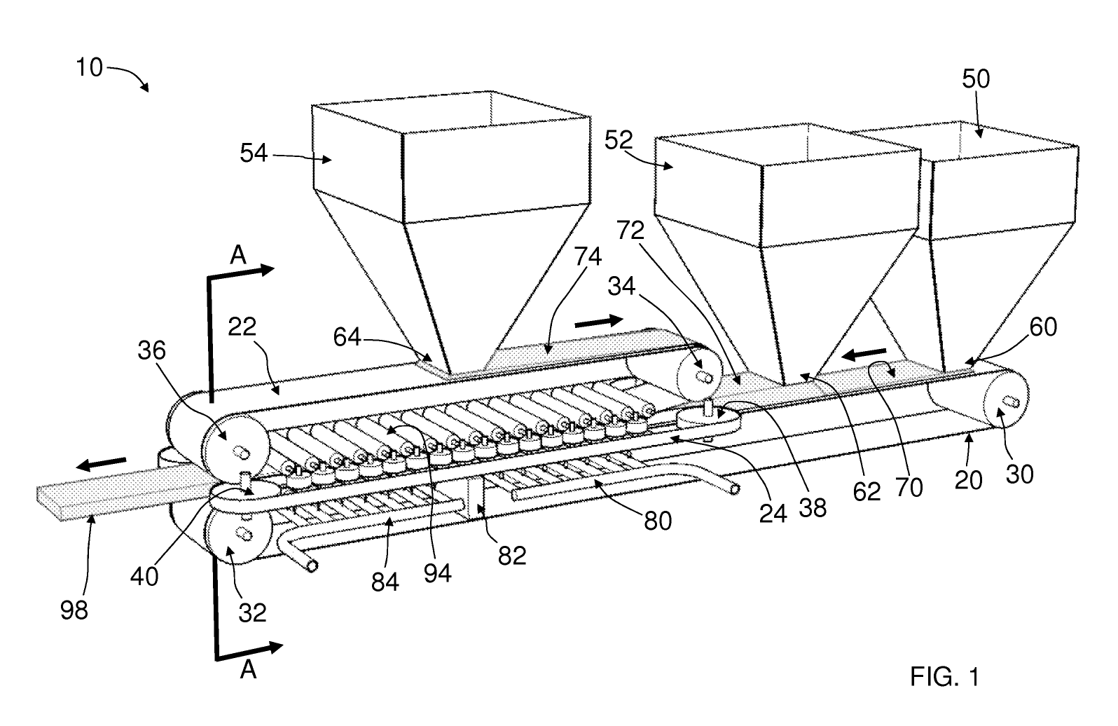

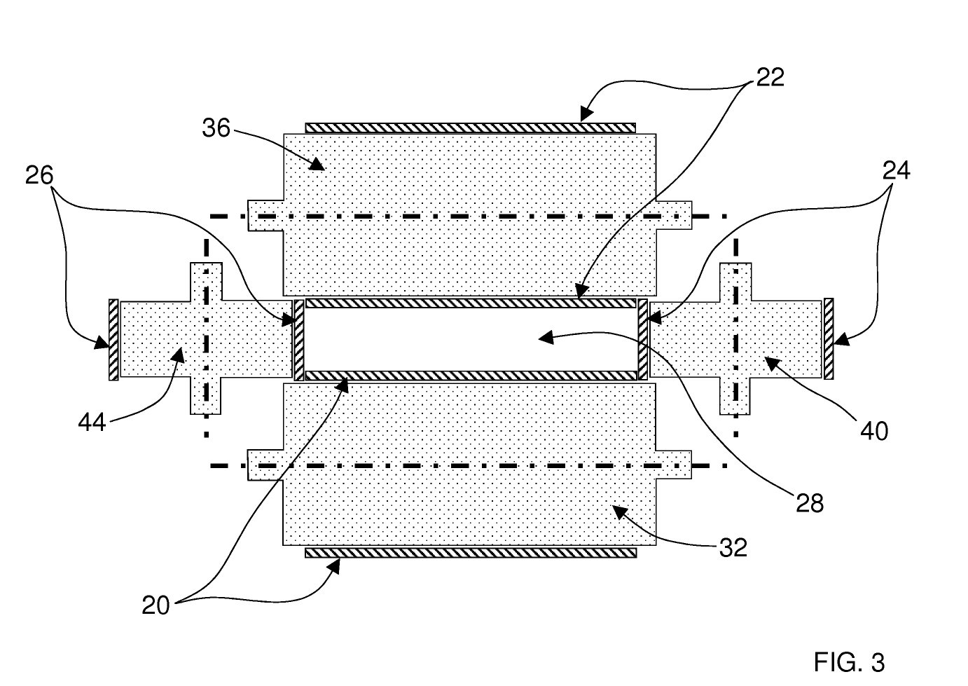

Referring now to the drawings, wherein like reference numerals designate identical or corresponding parts throughout the several views, a molding apparatus 10 constructed in accordance with an embodiment of the invention is illustrated in FIG. 1. The molding apparatus 10 may include a plurality of continuous belts 20, 22, 24, 26 disposed around a plurality of pulleys 30, 32, 34, 36, 38, 40, 42, 44. Each continuous belt may be disposed around at least two corresponding pulleys. For example, in FIG. 1, continuous belt 20 is disposed around pulley 30 and pulley 32. It is preferred that the continuous belts be made from stainless steel, but other materials having adequate thermal conductivity, mechanical properties, temperature resistance, and release properties may be substituted. The belts may be disposed in proximity to one another and arranged such that a tubular passageway 28 is formed therebetween. FIG. 3 shows a cross sectional view through the tubular passageway 28 and surrounding belts and pulleys of the embodiment illustrated in FIG. 1. It is preferred that the tubular passageway 28 so formed be completely sealed in cross section (as shown in FIG. 3), with each belt disposed in direct contact with adjacent belts. However, in some cases the tubular passageway may be only partially sealed. For example, if only two belts are used, corresponding to belts 20 and 22, a substantially rectangular tubular passageway may be formed that is sealed on two sides but open on two sides. Alternatively, it is possible that four continuous belts 20, 22, 24, 26 may be used, but gaps may be left at the interfaces therebetween, resulting in a tubular passageway that is not completely sealed. It is preferred that the tubular passageway 28 have four sides as illustrated in FIG. 3, though in some embodiments the tubular passageway 28 may have a different number of sides.

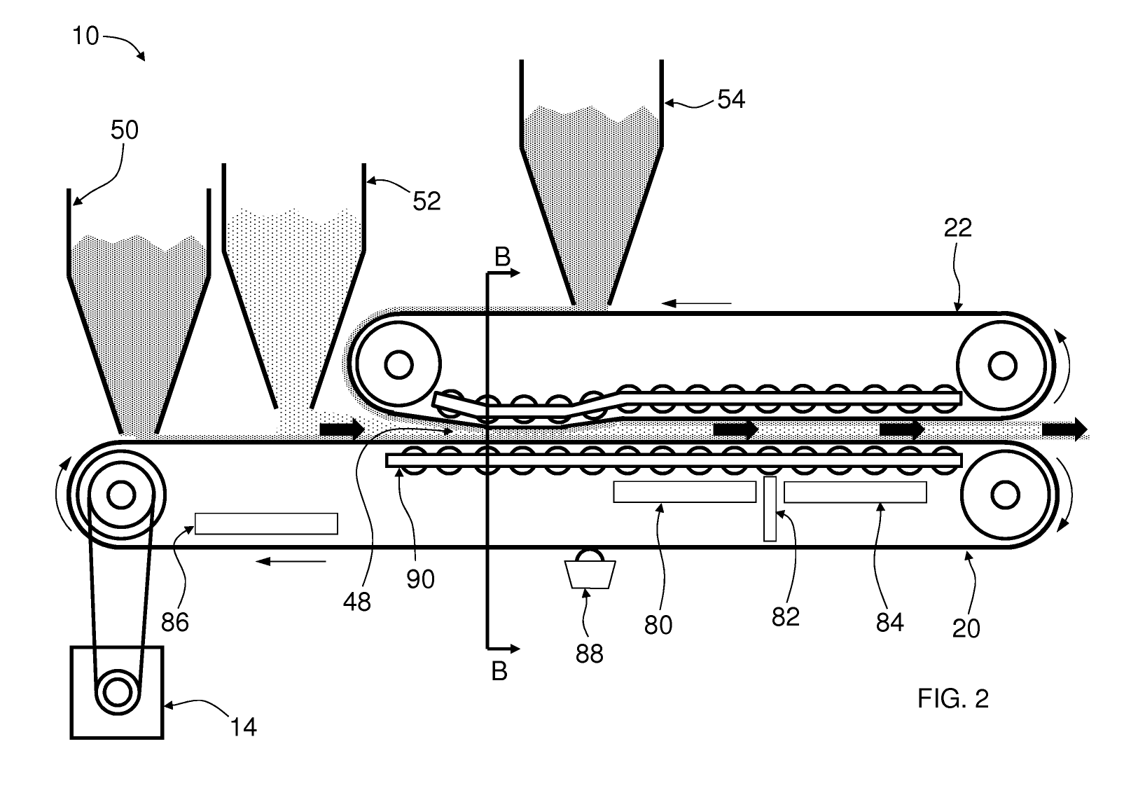

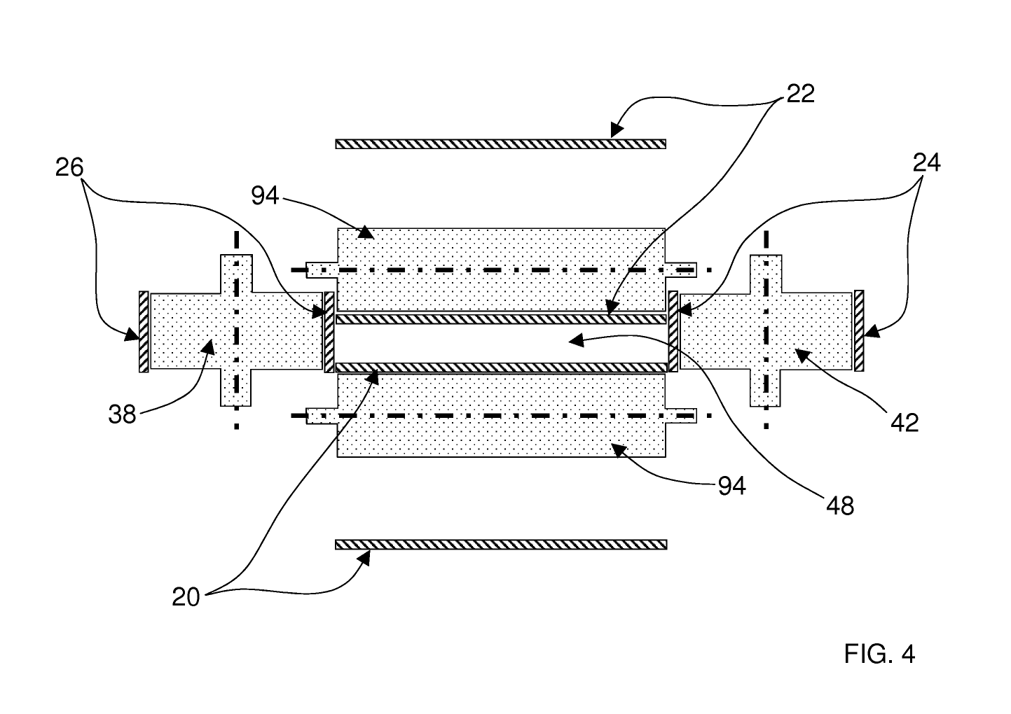

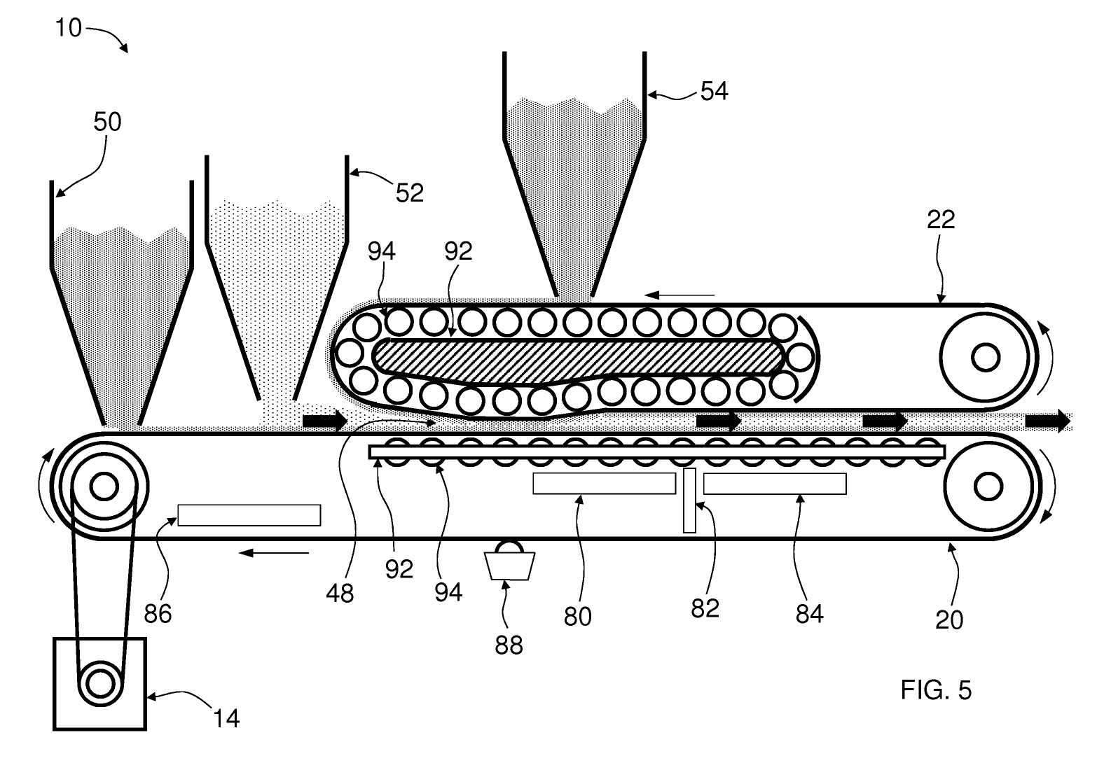

Although the tubular passageway 28 may be of uniform cross section throughout its length, in some embodiments the cross sectional area of the tubular passageway 28 may be locally reduced at a location 48 near the entrance to said tubular passageway 28 as illustrated in FIG. 2, FIG. 4 and FIG. 5. The localized reduction in cross sectional area of the tubular passageway 28 at the location 48 may cause material constrained within or passing through said tubular passageway to be squeezed, compressed, or further constrained, and may prevent pressure generated during the molding process from escaping and/or forcing plastic material through the entrance to the said tubular passageway 28. The tubular passageway cross section may reach a minimum at a single location, forming a pinch point. Alternatively, the tubular passageway may be maintained at a constant reduced cross section over some portion of the tubular passageway's length. The entrance to the tubular passageway may receive plastic material in a granular, shredded, or powdered state having a bulk density significantly lower than the solid density of the plastic material itself. The tubular passageway or the entrance thereto may be configured to progressively squeeze the individual particles of plastic together until the region of the tubular passageway having a minimum cross section is reached. The bulk density of the plastic particles in this region may approach the solid density of the plastic material from which the plastic particles are formed. This compacted material may form a plug capable of resisting back-flow of plastic particles and/or gas. In some embodiments, the cross sectional area of the tubular passageway 28 may occur abruptly at the entrance to said tubular passageway. However, it may be advantageous in some cases to reduce the cross sectional area gradually so as to minimize disruption of the plastic particles as they are compressed.

One continuous belt 20 may be disposed beneath another continuous belt 22. The lower continuous belt 20 may be longer than the upper continuous belt 22, allowing the upper surface of each belt to be accessed to facilitate the application of plastic or other materials thereto.

Plastic material applicators 60, 62, 64 may be disposed proximate to one or more of the continuous belts 20, 22. It is preferred that the plastic material applicators be disposed above an upper surface of the continuous belts 20, 22. The plastic material applicators may comprise gravity-fed apertures spaced a distance above the upper surface of the continuous belts as illustrated in FIG. 1. Granular, powdered, or shredded plastic material may flow through the apertures, coming to rest on the continuous belts and building up thereon. Because of the flow characteristics of granular, powdered, and shredded materials, a stoppage in the flow may be created once the space between an aperture and a continuous belt has been filled. Movement of the continuous belts around their respective pulleys relative to the stationary apertures may cause plastic material to be drawn out from under each aperture, said plastic material being spread across portions of the surfaces of the continuous belts. When plastic material is drawn out from under the apertures, voids may be formed between the apertures and the continuous belts, thus enabling replacement plastic material, urged by gravity, to flow from the hoppers, through the apertures, and onto the continuous belts. In some embodiments of the invention, the plastic material applicators may comprise an active system for metering, conveying, and depositing plastic material onto one or more continuous belts. Metering may be implemented on a volumetric or gravimetric basis and by any means known in the art. In some embodiments, plastic may be applied to at least one continuous belt other than on its upper surface. In some embodiments, as illustrated in FIG. 1, a plastic layer 72 may be deposited by one plastic material applicator 62 over another plastic layer 70 previously deposited by a different plastic material applicator 60. In some embodiments, and as illustrated in FIG. 1, a plastic layer 74 may be deposited by a plastic material applicator 64 onto an upper surface of an upper continuous belt 22. In such an embodiment, the plastic material may be transferred to a lower surface of an upper continuous belt 22 by advancing the belt around pulleys 34, 36. This may cause the plastic material deposited on the upper surface of the upper continuous belt 22 to enter the tubular passageway 28 cooperatively formed by the continuous belts 20, 22, 24, 26 and to contribute to the formation of a molded plastic article 98 therein.

The plastic material applicators 60, 62, 64 may deposit different forms, grades, compositions, or types of plastic. In some embodiments, multiple plastic material applicators may deposit identical materials. For example, plastic material applicators 60 and 64 may deposit a first type of plastic material suitable for forming a high density plastic skin, while plastic material applicator 62 may deposit a second type of plastic material suitable for forming a low density core. Although three plastic material applicators 60, 62, 64 are preferred and are illustrated in FIG. 1, a different number of plastic material applicators may be employed. For example, a single plastic material applicator may be used where a plastic article with a single plastic composition is desired. Alternatively, more than three plastic material applicators may be employed if a plastic article composed of more than three distinct layers or material types is desired. Furthermore, material applicators for non-plastic materials and/or manual placement may be employed to incorporate non-plastic materials such as fiber reinforcement into portions of a plastic article molded by the apparatus 10. For example, natural fibers such as hemp, cotton, flax and the like, synthetic fibers such as fiberglass, carbon, and the like, and recycled fibers of either natural or synthetic origin may be incorporated into a plastic article molded by the apparatus 10. This may be accomplished by mixing fibers into the plastic supply feeding the plastic material applicators, 60, 62, 64, or by placing the fibers as discrete layers on top of skin plastic layers 70, 74 where they will end up encapsulated inside the finished plastic part, yet remain near the surface to maximize their structural effectiveness. The fibers may be placed as discrete layers by automated fiber applicators, or by manually placing fibers on the exposed skin plastic layers 70, 74. For example, fibrous material may be unwound from a roll automatically and drawn into the tubular passageway 28 by the motion of the continuous belts. Alternatively or additionally, fibrous materials of non-uniform sizes and shapes, and particularly recycled fibrous materials, may be manually placed on exposed portions of plastic layers such as plastic layers 70 and 74 of FIG. 1. Manual placement may enable recycled fibrous material pieces of unpredictable sizes and shapes to be layed as a patchwork to form a fibrous layer of relatively uniform thickness. This may permit otherwise unusable materials to be incorporated into a molded plastic article 98 while maintaining relatively predictable properties.

The plastic material applicators 60, 62, 64 may be supplied with plastic material by corresponding plastic material supply hoppers 50, 52, 54. The hoppers may be disposed above the plastic material applicators, facilitating gravity flow therebetween. Alternatively, the hoppers may be disposed apart from or below the plastic material applicators, and alternative means of conveyance may be employed to transfer material from the plastic material supply hoppers to the plastic material applicators. In some embodiments, the plastic material applicators may be fed directly by a grinder, shredder, pulverizer, or the like, and an intermediate hopper may not be required.

A drive motor 14 may be mechanically coupled to at least one of the pulleys 30, 32, 34, 36, 38, 40, 42, 44 and may cause at least one of the continuous belts 20, 22, 24, 26 to advance at a controlled rate. It is preferable that the motor 14 be coupled to all of the continuous belts forming the tubular passageway 28 so as to ensure that all of the said continuous belts move in unison. Alternatively, multiple motors may be employed to drive the various belts, or some belts may be left undriven. Undriven belts may serve as idler belts and may passively move in unison with the other belts, urged on by drag from the plastic material in contact therewith.

A heater 80 may be disposed proximate to the tubular passageway 28 and may heat those portions of the continuous belts that are proximate to the heater 80 as well as any plastic material present within the tubular passageway 28 proximate to the heater 80. The plastic within the tubular passageway 28 may be heated by conduction through at least one of the continuous belts 20, 22, 24, 26 forming the walls thereof. The heater 80 may be disposed proximate to a first portion of the tubular passageway 28 relative to the direction of plastic flow therethrough. The heater 80 may preferably be of the direct flame impingement type, and may comprise a network of tubes through which a gaseous fuel may flow and a plurality of apertures through which said fuel may exit and combust. Flames from the heater 80 may impinge directly on the inner surface of the belt 20. Although only one heater is shown in FIG. 1 for clarity, it is preferred that multiple heaters be employed to heat multiple belts at once, thus heating the tubular passageway 28 and the contents thereof from multiple directions. In some embodiments, the heater 80 may be of the hot air, electric, infrared, induction, or other heater type known in the art.

It may be beneficial for the continuous belts 20, 22 or portions thereof proximate to the plastic material applicators 60, 62, 64 to be heated to an intermediate temperature. The intermediate temperature to which portions of the continuous belts may be heated may be higher than the temperature of those portions of the continuous belts in close proximity to the cooler 84, but lower than the temperature of those portions of the continuous belts in close proximity to the heater 80. Heating to the intermediate temperature may promote rapid sintering of the plastic particles deposited on the belts by the plastic material applicators 60, 62, 64 and may facilitate adhesion of the plastic material to the continuous belts 20, 22. Such adhesion may be particularly beneficial in the case of those embodiments in which plastic material is expected to cling to a continuous belt in an inverted position. For example, plastic material 74 is expected to cling to continuous belt 22 as it travels around pulley 34 just prior to entry of said plastic material 74 into tubular passageway 28 of the embodiment of the invention illustrated in FIG. 1. The heat for heating portions of the continuous belts to an intermediate temperature may be derived from the waste heat or exhaust gasses of heater 80. If the heater 80 is unable to provide sufficient waste heat to preheat the continuous belts adequately, or if better control is desired, one or more auxiliary heater 86 may be employed to preheat portions of the continuous belts 20, 22 as required.

A cooler 84 may be disposed proximate to the tubular passageway 28 and may cool those portions of the continuous belts that are proximate to the cooler 84 as well as any plastic material present within the tubular passageway 28 proximate to the cooler 84. The plastic within the tubular passageway 28 may be cooled by conduction through at least one of the continuous belts 20, 22, 24, 26 forming the walls thereof. The cooler 84 may be disposed proximate to a second portion of the tubular passageway 28, following the portion proximate to the heater 80 relative to the direction of plastic flow therethrough. The cooler 84 may preferably be of the water mist type, and may comprise a network of tubes through which water may flow and a plurality of apertures or atomizing nozzles through which said water may emerge as a mist. Mist from the cooler 84 may impinge directly on the inner surface of the belt 20. Although omitted from FIG. 1 for clarity, it is preferred that multiple coolers be employed to cool multiple belts at once, thus cooling the tubular passageway 28 and the contents thereof from multiple directions. In some embodiments, the cooler 84 may be of the compressed air jet, water spray, water saturated contact sponge, or other cooler type known in the art.

An insulative barrier 82 may separate a portion of the continuous belt 20 proximate to the heater 80 from a portion of the continuous belt 20 proximate to the cooler 84. A frame 12 may be provided to maintain the components of the apparatus 10 in their respective positions.

A force reacting structure 90, illustrated in FIG. 2, may be disposed adjacent to the tubular passageway 28. The force reacting structure may serve to resist pressure generated inside the tubular passageway 28 and may resist outward deflection of those planar portions of the continuous belts forming the walls of the tubular passageway. The force reacting structure 90 may comprise a structural support 92 and at least one contact feature 94 for making contact with a planar portion of at least one of the belts. The contact feature 94 may comprise a low-friction surface for making sliding contact with the at least one belt, a plurality of recirculating rollers, a plurality of shaft-mounted rollers, a plurality of balls, or a plurality of other rolling elements for making rolling contact with the at least one belt. Different portions of the apparatus may employ different contact feature types simultaneously. For example, a single apparatus may be constructed with recirculating rollers making contact with one belt, while shaft-mounted rollers make contact with another belt as illustrated in FIG. 5. Alternatively or additionally, different contact feature types may be utilized within a single belt. For example, recirculating rollers may be used adjacent to those portions of the belts in which the tubular passage 28 cross section is reduced, while shaft-mounted rollers may be used adjacent to other portions of the same belts. In those embodiments utilizing recirculating rollers as contact features, it may be beneficial for the rollers to be formed from a material having a low thermal conductivity and/or a low heat capacity. This may minimize the energy expended to heat and cool the rollers. The force reacting structure 90 may counteract pressure exerted on the belts from within the tubular passageway 28 during the evolution of gas from a blowing agent present in the plastic material.

In some embodiments, it may be desirable to apply a release agent to one or more of the continuous belts prior to depositing plastic material thereon. The release agent may serve to enable the plastic article formed by means of the present invention to be removed from the apparatus without damage to either the plastic article or the apparatus. In some cases, release agent may be applied periodically by manual means. However, in some embodiments, a release agent applicator 88 may be employed to continuously and automatically deposit release agent onto one or more of the continuous belts 20, 22, 24, 26 during the operation of the apparatus 10. The release agent applicator 88 may apply release agent by means of a contact roller, contact sponge, brush, mister, spray nozzle, or the like. It is preferred that the release agent applicator be positioned such that release agent is applied to a continuous belt prior to the auxiliary heater 86 or heater 80 relative to the direction of belt motion through the apparatus 10.

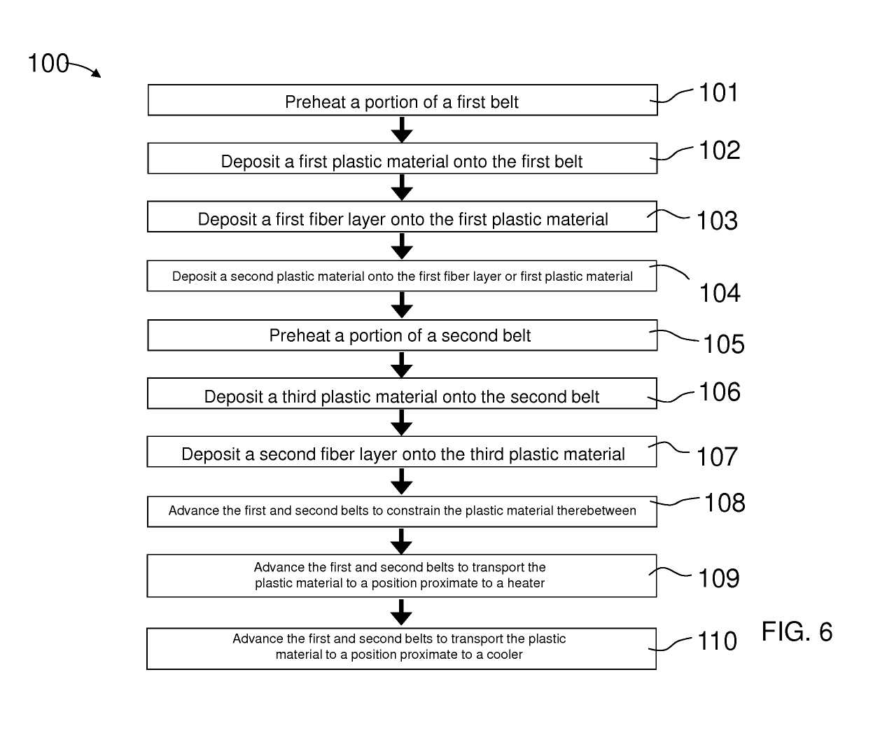

Steps of a method 100 for molding a plastic article 98 in accordance with various embodiments of the present invention are illustrated in FIG. 6. The steps may be performed in the order shown in FIG. 6, or they may be performed in a different order. Some steps may be performed concurrently rather than consecutively and some steps may be omitted.

Referring to step 101, a first belt, such as the first continuous belt 20 of the apparatus illustrated in FIG. 1, or some portion thereof may be preheated.

Referring to step 102, a first plastic material may be deposited onto a first belt, such as the first continuous belt 20 of the apparatus illustrated in FIG. 1.

Referring to step 103, a first fiber layer may be deposited onto the first plastic material.

Referring to step 104, a second plastic material such as the material forming the plastic layer 72 illustrated in FIG. 1 may be deposited onto the first plastic material such as the material forming the plastic layer 70 in FIG. 1.

Referring to step 105, a second belt, such as the second continuous belt 22 of the apparatus illustrated in FIG. 1, or some portion thereof may be preheated.

Referring to step 106, a third plastic material may be deposited onto a second belt, such as the second continuous belt 22 of the apparatus illustrated in FIG. 1.

Referring to step 107, a second fiber layer may be deposited onto a third plastic material.

Referring to step 108, the first belt and second belt may be advanced, transporting plastic material deposited on exposed surfaces of said belts to a position between said belts such that the material is constrained thereby.

Referring to step 109, the first belt and second belt may be advanced, transporting plastic material constrained therebetween to a position proximate to a heater.

Referring to step 110, the first belt and second belt may be advanced, transporting plastic material constrained therebetween to a position proximate to a cooler.

Although method steps 102, 104, and 106 refer to a first plastic material, a second plastic material, and a third plastic material, the form and composition of some or all of these materials may be identical. For example, the first plastic material and the third plastic material may be identical and may be suitable for forming the skins of the plastic article 98. The second plastic material may differ from the first plastic material and the third plastic material, and may be suitable for forming the core of the plastic article 98.

Having thus described various embodiments of the invention, what is claimed as new and desired to be protected by Letters Patent includes the following:

1. An apparatus for molding a plastic article from plastic material, the apparatus comprising:
a first continuous belt having a first surface configured to define a first surface feature of the plastic article during molding, said first continuous belt having a second surface opposite said first surface;
a second continuous belt having a first surface configured to define a second surface feature of the plastic article during molding, said second continuous belt having a second surface opposite said first surface;
a heater configured to heat at least one of said second surface of said first continuous belt and said second surface of said second continuous belt;
a cooler configured to cool at least one of said second surface of said first continuous belt and said second surface of said second continuous belt;
wherein said first continuous belt and said second continuous belt are disposed and configured to cooperatively constrain plastic material therebetween.

2. The apparatus of claim 1, further comprising:
a first plastic material applicator configured to deposit a first plastic material onto said first surface of said first continuous belt;
a second plastic material applicator configured to deposit a second plastic material onto said first plastic material;
a third plastic material applicator configured to deposit a third plastic material onto said first surface of said second continuous belt.

3. The apparatus of claim 2, wherein said first plastic material and said third plastic material are substantially identical.

4. The apparatus of claim 2, wherein said second plastic material contains a blowing agent.

5. The apparatus of claim 2, wherein said second continuous belt passes around a pulley positioned between said third plastic material applicator and said heater.

6. The apparatus of claim 1, further comprising a third continuous belt and a fourth continuous belt configured to cooperate with said first continuous belt and said second continuous belt adapted to constrain granular, powdered, or shredded plastic material therebetween, wherein said first continuous belt, said second continuous belt, said third continuous belt, and said forth continuous belt together form a tubular passageway having a four-sided polygonal cross section.

7. The apparatus of claim 6, wherein a cross sectional area of said tubular passageway is reduced near an entrance to said tubular passageway.

8. The apparatus of claim 1, further comprising a force reacting structure in contact with said second surface of said first belt, and configured to limit the displacement of said first belt toward said force reacting structure.

9. The apparatus of claim 8, wherein said force reacting structure comprises a plurality of recirculating rollers.

10. The apparatus of claim 1, wherein said first continuous belt is disposed beneath said second continuous belt, and at least a portion of said first continuous belt extends beyond said second continuous belt.

11. The apparatus of claim 1, further comprising a motor configured to drive at least one of said first belt and said second belt.

12. The apparatus of claim 1, wherein said heater is chosen from a group of heaters consisting of a direct flame impingement heater, a hot air heater, and an induction heater.

13. The apparatus of claim 1, further comprising a release agent applicator configured to apply a release agent to at least one of said first surface of said first belt and said first surface of said second belt.

14. An apparatus for forming a plastic article from a granular, shredded, or powdered plastic material feedstock, the apparatus comprising:
a first continuous belt disposed around a first pulley and a second pulley and having a planar portion therebetween;
a second continuous belt disposed around a third pulley and a forth pulley and having a planar portion therebetween;
a third continuous belt disposed around a fifth pulley and a sixth pulley and having a planar portion therebetween;
a forth continuous belt disposed around a seventh pulley and an eighth pulley and having a planar portion therebetween;
wherein said planar portions of said first continuous belt, said second continuous belt, said third continuous belt, and said forth continuous belt are disposed adjacent to one another so as to form a tubular passageway therebetween, said tubular passageway having a four-sided polygonal cross section;
a first plastic material applicator configured to deposit plastic material onto at least one of said first continuous belt, said second continuous belt, said third continuous belt, and said forth continuous belt;
a heater configured to heat a first location, wherein said first location is proximate to said tubular passageway;
a cooler configured to cool a second location, wherein said second location is spaced apart from said first location and proximate to said tubular passageway;
a force reacting structure configured to resist internal pressure within said tubular passageway formed between said first continuous belt, said second continuous belt, said third continuous belt, and said forth continuous belt, by contacting a surface of at least one of said belts.

15. The apparatus of claim 14, further comprising a second plastic material applicator spaced apart from said first plastic material applicator and adapted to be supplied with plastic material distinct from said plastic material supplied to said first plastic material applicator.

16. A method for molding a plastic article comprising the steps of:
depositing a first plastic material onto a first continuous belt;
depositing a second plastic material onto a first plastic material;
depositing a third plastic material onto a second continuous belt;
advancing a first continuous belt and a second continuous belt in unison to cooperatively constrain said first plastic material, said second plastic material, and said third plastic material therebetween;
advancing said first continuous belt and said second continuous belt in unison to bring said first plastic material, said second plastic material, and said third plastic material into a position proximate to a heater;
advancing said first continuous belt and said second continuous belt in unison to bring said first plastic material, said second plastic material, and said third plastic material into a position proximate to a cooler.

17. The method of claim 16, further comprising the step of advancing a third continuous belt and a forth continuous belt in unison with said first continuous belt.

18. The method of claim 16, further comprising the step of cutting said plastic article to a desired length via a means for cutting.

19. The method of claim 16, further comprising the step of pre-heating a portion of said second continuous belt to a chosen temperature prior to depositing said third plastic material thereon, wherein said chosen temperature is adapted to be higher than a temperature proximate to said cooler and lower than a temperature proximate to said heater.

20. The method of claim 16, further comprising the step of depositing a layer of fibrous reinforcement material onto said first plastic material prior to the application of said second plastic material, such that said fibrous reinforcement material is sandwiched between.
